(19) United States
(12) Patent Application Publication
(10) Pub. No.: US 2016/0144968 A1
(43) Pub. Date: May 26, 2016

(54) METHOD OF FLYING AN AIRCRAFT

(71) Applicant: Naomi Kikuchi, Niigata (JP)

(72) Inventor: Naomi Kikuchi, Niigata (JP)

(21) Appl. No.: 14/933,235

(22) Filed: Nov. 5, 2015

(30) Foreign Application Priority Data
Nov. 25, 2014 (JP) 2014-237585

(51) Int. Cl. B64D 27/18; B64C 3/10; B64D 27/02

(52) U.S. Cl. CPC B64D 27/18; B64D 27/023; B64C 3/10

(57) ABSTRACT

Provided is a fuel-efficient method of flying an aircraft for flying an aircraft. The present invention relates to a method of flying an aircraft 1 having a fuselage 2, primary wings 3, and high-power engines 6 serving as driving units for generating a thrust. The method of flying an aircraft comprising: determining a combination of said primary wings 3 and high-power engines 6 so that a total wing area of said primary wings 2 is proportionally correlated to an power output of said high-power engines 6, generating a comparatively large lifting power using said primary wings 3 having large wing areas, elevating said aircraft 1 to a high altitude, and flying said aircraft 1 at high speeds and altitudes using said high-power engine 6.

### BACKGROUND OF THE INVENTION

1. Field of the Invention

The present invention relates to a method of flying an aircraft enabling high-speed and fuel-efficient flying.

2. Background Art

Conventionally, there are known aircrafts as disclosed, for example, in FIG. 1 of Japanese Unexamined Patent Application Publication No. H05-286498. Such aircrafts include a single engine provided for each one of the left-and-right primary wings. For that reason, power outputs of the engines are not large enough, thereby being not capable of producing large thrusting powers, thus making it difficult for the aircrafts to fly at high speeds.

Further, a total wing area such primary wings are not sufficiently large and thus lifting powers produced by primary wings are not large enough, thereby making it difficult for the aircrafts to be elevated to a high altitude.

### SUMMARY OF THE INVENTION

Hence, such conventional aircrafts have no choice but to fly in relatively low altitude. Moreover, conventional aircrafts are easily affected by large air resistances in a direction opposite to the moving direction when flying at low altitude since atmospheric pressure is high in such low altitudes. For this reason, aircrafts get decelerated due to such air resistances, thereby making it difficult for them to fly at high speeds. Further, when traveling long distances, conventional aircrafts have a problem of taking a fair amount of time traveling therethrough.

Furthermore, due to the large air resistances, conventional aircrafts have a problem of spending too much engine fuels for generating a thrust.

In view of the aforementioned problems, it is an object of the present invention to provide a method of flying an aircraft with which duration of a flight is to be reduced through the flight of a high altitude. Moreover, it is also an object of the present invention to provide an aircraft flying method with which fuel consumptions during flight are to be reduced.

### Means of Solving the Problems

A first aspect of the present invention is a method of flying an aircraft having a fuselage, primary wings, and driving units for generating a thrust, the method including: determining a combination of the primary wings and the driving units so that a total wing area of the primary wings is proportionally correlated to an total power output of the driving units, generating a comparatively large lifting power using the primary wings having large wing areas, elevating the aircraft to a high altitude by the lifting power, and flying the aircraft 1 at high speeds and altitudes using high thrusting powers generated by the driving units.

A second aspect of the present invention is the method of flying an aircraft according to the first aspect, wherein the method comprises: decelerating the aircraft to a predetermined flying speed through stopping the driving units from generating the thrust; and thereafter making a landing.

A third aspect of the present invention is the method of flying an aircraft according to the first aspect or the second aspect, wherein the primary wings are delta wings having sweptback angles.

A fourth aspect of the present invention is the method of flying an aircraft according to any one of the preceding aspects, wherein the driving units are jet engines.

A fifth aspect of the present invention is the method of flying an aircraft according to any one of the preceding aspects, wherein the driving units are rocket engines.

### Effects of the Invention

According to the first aspect of the present invention, duration of a flight is reduced through flying a high altitude. Moreover, fuel consumptions during flights are allowed to be reduced.

According to the second aspect of the present invention, fuel consumptions during descents are reduced.

According to the third aspect of the present invention, there can be obtained large lifting powers.

According to the fourth aspect of the present invention, there can be obtained sufficient thrusts when traveling thorough the atmosphere.

According to the fifth aspect of the present invention, there can be obtained sufficient thrusts when traveling thorough a high altitude having a reduced atmospheric pressure.

### BRIEF DESCRIPTION OF THE DRAWINGS

FIG. 1 is a plane view of an aircraft showing a first embodiment of the present invention.

FIG. 2 is a plane view of a conventional aircraft.

FIG. 3 shows a diagram comparing a flight path of an aircraft according to the first embodiment of the present invention to that of a conventional aircraft.

### DETAILED DESCRIPTION OF THE INVENTION

Preferred embodiments of the present invention are described with reference to the accompanying drawings. However, the embodiments described hereunder shall not limit the contents of the present invention that are found in the scope of claims. Further, not all elements described hereunder are necessarily the essential elements of the present invention.

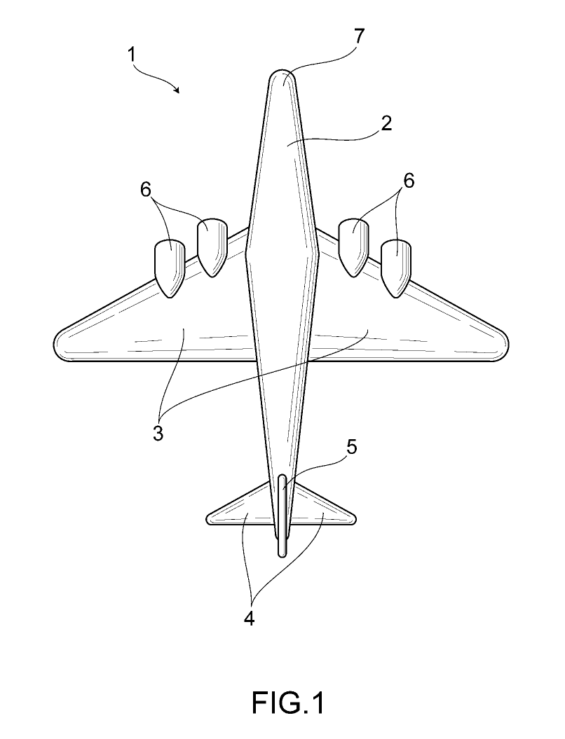

An embodiment of the present invention will be described hereunder with reference to FIGS. 1 to 3.

FIG. 1 shows an aircraft 1 according to one embodiment of the present invention. The aircraft 1 comprises a fuselage 2, primary wings 3 attached to the lateral sides of the fuselage 2 and provided in about a middle portion in a front-rear direction of the fuselage 2, tail-planes 4 attached to the lateral sides of the fuselage 2 and provided in the rear of the body 2, a vertical tail 5 attached to the upper side of the fuselage 2 and provided in the vicinity of the rear end of the fuselage 2, and engine(s) 6 serving as driving unit(s) that is/are respectively attached to left-and-right primary wings 3.

As shown in the figure, delta wings having sweptback angles are employed as the primary wings of the present embodiment to ensure large and sufficient wing area. According to the present embodiment, two engines 6 are attached to each one of the left-and-right primary wings 3. However, if total power outputs of the engines 6 employed are sufficiently large, the engines 6 may be singly provided for each one of the left and right primary wings 3. Further there may be employed an increased number of engines 6 to gain a more powerful thrust.

In the present embodiment, a total wing area of the primary wings 3 need to be increased if the total power output of the engines 6 is increased through, e.g., the increase of the engines 6. In this case, the total wing area of the primary wings 3 are to be adjusted through making a change to a chord length and a wingspan of the primary wings 3. Further, although a delta wing is employed for the primary wings 3 of the present embodiment, a total wing area of the primary wings may be adjusted through employing other shapes for the primary wings 3.

Each of the tail-planes 4 is sweptback and has a nearly triangular shape as viewed from a plane surface. The tail-planes 4 serve to stabilize up-and-down motions of the nose 7 of the aircraft 1. Specifically, when the nose 7 turns upward relative to a horizontal direction, there are generated positive angles of attack for the tail-planes 4, causing the tail-planes 4 to be subjected to lifting powers, thus rotating the aircraft 1 into a direction in which the nose 7 turns downward around the center of gravity of the aircraft 1. Likewise, when the nose 7 turns downward, there are generated negative angles of attack for the tail-planes 4, which causes the tail-planes 4 to be subjected to downward forces, thus rotating the aircraft 1 in a direction in which the nose 7 turns upward around the center of gravity of the aircraft 1.

According to the present embodiment, the tail-planes 4 are attached such that angles of attack for the tail-planes 4 get negative when the fuselage 2 of the aircraft 1 is horizontally positioned. However, installation angles of the tail-planes 4 can be appropriately changed.

The wider wing areas of the tail-planes 4 becomes the better stabilizing effects is provided to the pitching motions of the aircraft 1. Also, the longer a distance from the tail-planes 4 to the center of gravity of the aircraft 1 gets, the better stabilizing effects against pitching motions of the aircraft 1 become. Consequently, wing areas and locations of the tail-planes 4 may be appropriately changed to achieve a better stability on the pitching motion of the aircraft 1.

A vertical tail 5 has a nearly trapezoidal shape in a side view with its upper portion tapered and pointing upward. The vertical tail 5 serves to stabilize sidewise motions of the nose 7 of the aircraft 1.

Specifically, when the nose 7 is swung leftward, there is generated an angle of attack between the vertical tail 5 and the direction in which the aircraft 1 is moving, causing the vertical tail 5 to be subjected to steering forces to the left, thus allowing the aircraft 1 to be rotated in a direction in which the nose 7 turns rightward. Likewise, when the nose 7 turns rightward, there are generated an angle of attack between the vertical tail 5 and the direction in which the aircraft 1 is moving, generating steering forces for the tail-planes 4 to the right, thus allowing the aircraft 1 to be rotated in a direction in which the nose 7 turns leftward.

The wider wing area of the vertical tail 5 becomes the better the stabilizing effects is provided against the sidewise motions of the aircraft 1. Also, the longer a distance from the vertical tail 5 to the center of gravity of the aircraft 1 becomes, the better stabilizing effects against sidewise motions of the aircraft 1 get. Consequently, the wing area and arrangements of the vertical tail 5 may be appropriately changed to achieve a better stability on the sidewise motion of the aircraft 1.

Jet engines or rocket engines can be employed as the engines 6 for generating a thrust for the aircraft 1. The jet engines take air (or oxygen) from intakes (not shown) provided on the front, compress the air (or oxygen) taken therefrom, and then mix the compressed air with fuels. After that, the mixture is burned to give off hot pressurized exhaust gases that are blasted out backward through exhaust ports (not shown) arranged at the rear of the aircraft 1. The reaction force of this blast propels the aircraft 1. As discussed above, jet engines require the air (or oxygen) to generate a driving force. Consequently, if the aircraft 1 is expected to travel through the air where oxygen concentration is above a predetermined level, there can be employed a jet engine as the engine 6 to gain a sufficient thrust by taking the air (or oxygen) into the engines 6 from ambient air.

On the other hand, if the aircraft 1 is expected to travel through a domain where oxygen concentration is below the predetermined level, a rocket engine is to be employed. Rocket engines are configured to contain oxygen for combusting fuel. For this reason, unlike jet engines, there is no need to take oxygen from ambient air. Hence, in case where the aircraft 1 is expected to fly through a domain where oxygen concentration is low, rocket engines can be employed as the engines 6 for producing a sufficient thrusting power.

In this way, type of engine can be appropriately selected in accordance with a flight domain to be traveled by the aircraft 1 of the present embodiment.

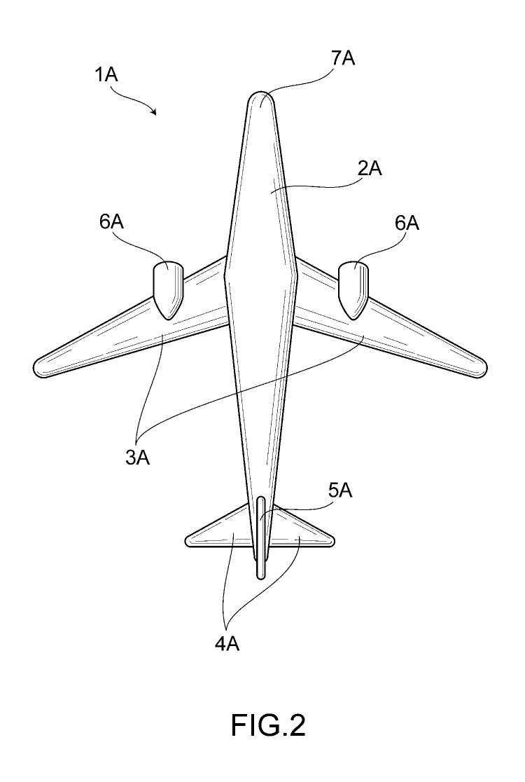

FIG. 2 shows a conventional aircraft 1A where wing areas of primary wings 3A are half of the primary wings 3 of the present aircraft 1. Further, for each of the left-and-right primary wings 3A of such aircraft 1A is provided a single engine 6A similar to the engine 6 of the aircraft 1. A fuselage 2A, tail-planes 4A, and vertical tail 5A, of the aircraft 1A are respectively identical to a fuselage 2, tail-planes 4, and vertical tail 5, of the aircraft 1. A method of flying the aircraft 1 of the present invention will be illustrated hereunder with reference to this aircraft 1A.

The aircraft 1A gains lifting power fin accordance with the wing area d of the primary wings 3A and total power output e, per unit time, of the two engines 6A. This lifting power f combined with the thrust generated by the engines 6A allow the aircraft 1A to be elevated to a height h where atmospheric pressure at that height is represented by the symbol “p”. The aircraft 1A raises to the height h and receives air resistance r in direction opposite to the moving direction when traveling through the air having the atmospheric pressure of p. This air resistance r together with total power output e determine the velocity v of the aircraft 1A at the atmospheric pressure p.

In contrast, the wing areas of the primary wings 3 of the present embodiment are twice as large as those of the primary wings 3A of conventional aircraft 1A. Moreover, the aircraft 1 of the present invention contains four engines 6 while the aircraft 1A of the conventional aircraft 1A has only two engine. Accordingly, power output E of the four engines 6 per unit time is twice as strong as the power e of the conventional two engines 6A of the aircraft 1A. As the result, by virtue of the wing areas and the power output E of the engine 6, the aircraft 1 are allowed to obtain large lifting power F larger than the power f achievable by the conventional aircraft 1A. The aircraft 1 is allowed to be elevated to a height H higher than the height h achievable by the conventional aircraft 1A through the use of that lifting power F and thrusts generated by the engines 6. Atmospheric pressure P at the height of H is lower than the pressure p at height h. Also, the aircraft 1 receives air resistance R in a direction opposite to the moving direction. Nonetheless, this air resistance R is smaller than the resistance r received by the aircraft 1A traveling through at height h. By virtue of this small air resistance R and total power output E, aircraft 1 is allowed to travel through the air of atmospheric pressure P at a flying speed of V faster than the speed v of the aircraft 1A.

Meanwhile, since intakes of the engines 6 and those of the engines 6A have identical sectional areas, the engine 6 of the aircraft 1 flying at a higher altitude takes seemingly less air (oxygen) intake per unit area of the intake. Yet, the flying speed V of the aircraft 1 is higher than the speed v of the conventional aircraft 1A. Therefore, air (or oxygen) intake per unit time, taken from the intake of the engines 6 of the aircraft 1 flying at a higher altitude, is comparable to that taken from the intake of the engines 6A flying at a lower altitude.

According to a method of the present invention, in the course of descent from a high altitude to the landing, the aircraft 1 stops the engines 6 to decelerate itself through air friction to a predetermined speed, e.g. 1000 km/h, and allows itself to lose altitude by the force of gravity until the aircraft 1 has reached a predetermined altitude. Generally speaking, sudden descent causes large air resistance, which in turn causes stress to the fuselage of the aircraft 1. However, according to this decelerating/descending method, the aircraft 1 is allowed to be decelerated and/or descended without causing stress to the fuselage of the aircraft 1. Further, fuel consumption is allowed to be reduced.

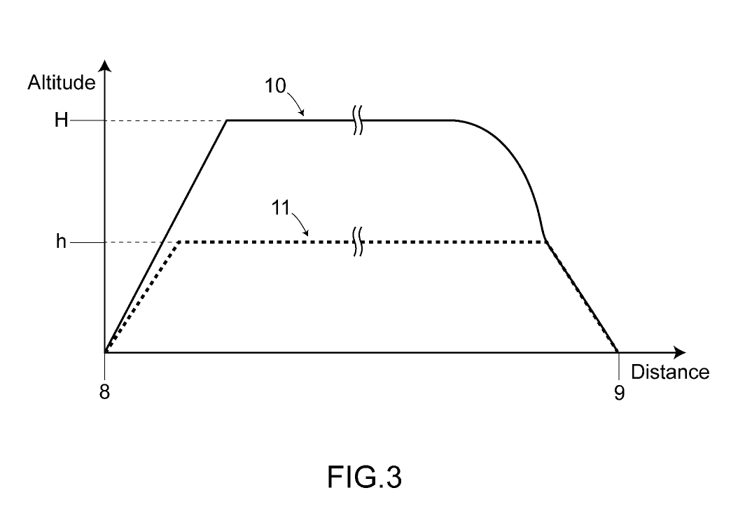

A method of flying the aircraft 1 will be illustrated hereunder with reference to FIG. 3 alongside of the conventional aircraft 1A. In FIG. 3, vertical axis represents the altitude and horizontal axis shows the flying distance. Also, the symbol represented by “8” is a takeoff point and the symbol “9” represents a landing point.

In FIG. 3, a flight line 10 is represented, showing the flight path of the aircraft 1. After the aircraft 1 is taken off at the takeoff point 8, the aircraft 1 is elevated to the altitude H while moving into the direction of the landing point 9. Having reached the height H, the aircraft 1 starts to fly horizontally to the direction of the landing point 9 at speed V. When the aircraft 1 have reached a predetermined distance from the landing point 9, powers of the engines 6 are shut off so as to allow the aircraft 1 to be decelerated by air resistance and, at the same time, to be descended by gravity. When aircraft 1 have sufficiently decelerated to a predetermined velocity, the engines 6 are reactivated in preparation for landing. The aircraft 1 is then further descended while adjusting its flying speed and altitude through controlling the power output of the engines 6 until the aircraft 1 is landed at the landing point 9.

In FIG. 3, a flight line 11 of the aircraft 1A is represented. After the aircraft 1A is taken off at the takeoff point 8, the aircraft 1 is elevated to the altitude h while moving into the direction of the landing point 9. Having reached the height h, the aircraft 1A starts to fly horizontally into the direction of the landing point 9 at speed v. The aircraft 1 is then further descended while adjusting its flying speed and altitude through controlling the power output of the engines 6A until the aircraft 1A is landed at the landing point 9.

Detailed description of the present embodiment will be illustrated with reference to the following specific conditions:
(1) Altitude H is defined to be 20,000 m while altitude h be 10,000 m.
(2) Total power output E of the aircraft 1 is set to be twice as strong as the power e of the conventional aircraft 1A.
(3) Wing areas of the primary wings 3 is set to be twice as large as those of primary wings 3A of the conventional aircraft 1A.
(4) Atmospheric pressure P at the height of H (or 20,000 m) is presupposed to be half the pressure p of that at the height of h (or 10,000 m).

According to the above described condition (2), the aircraft 1 flying at the altitude of h (10,000 m) is capable of flying twice as fast as the conventional aircraft 1A flying at the altitude of h (10,000 m). Further, according to the condition (4), the aircraft 1 flying at the height of H (20,000 m) is capable of flying twice as fast as the conventional aircraft 1A flying at the height of h (10,000 m). Owing to these two conditions, the aircraft 1, flying a high altitude of 20,000 m, is capable of flying four times as fast as the conventional aircraft 1A flying at the height h of 10,000 m.

According to the above described setting condition (2), the aircraft 1 consumes twice as much fuel as the conventional aircraft 1A. Nonetheless, the aircraft 1, flying a high altitude of H (20,000 m), is capable of flying four times as fast as the conventional aircraft 1A flying at the height of h (10,000 m). For these reasons, the aircraft 1 requires only one quarter of time necessary for burning the fuels compared with that of the conventional aircraft 1A provided that aircraft 1 of the present embodiment and the conventional aircraft 1A travel same distances. Consequently, amount of fuel consumption of the aircraft 1 is half of that of the conventional aircraft 1A. Accordingly, the method of flying the aircraft 1 reduces flight times and allows fuel-efficient flight.

Another conditions are described as below:
(5) Altitude H is defined to be 30,000 m while altitude h be 10,000 m.
(6) Total power output E of the aircraft 1 is set to be three times as strong as the power e of the conventional aircraft 1A.
(7) Wing areas of the primary wings 3 is set to be three times as large as those of primary wings 3A of the conventional aircraft 1A.
(8) Atmospheric pressure P at the height of H (or 30,000 m) is presupposed to be one third of the pressure p at the height of h (or 10,000 m).

According to the condition (6), the aircraft 1 is capable of flying nine times as fast as the conventional aircraft 1A. Also, aircraft 1 consumes only one third of fuel during entire flight compared with the conventional aircraft 1A.

In this way, the present invention allows the aircraft 1 to reduce flight time and the amount of fuel consumption through designing wing areas of the primary wings to be large and proportional to the total power output E of the engines 6. The wing areas of the primary wings and total power output E of the engines 6 are not limited to twice or three times as large as those of the conventional aircraft 1A. Rather, any appropriate number may be chosen for enlarging or multiplying the wing areas of the primary wings and total power output E. The aircraft 1 might get heavier as the number of engines 6 get increased. However, such weight gain is trifle in view of the total weight of the aircraft 1.

That is, according to the present embodiment, provided is a method of flying an aircraft 1 having a fuselage 2, primary wings 2, and engines 6 for generating a thrust. The method comprises: determining a combination of the primary wings 3 and the engines 6 so that total wing area of the primary wings 3 is proportionally correlated to a total power output of the engines 6, generating a comparatively large lifting power using the primary wings 3 having large wing areas, elevating the aircraft to a high altitude by the lifting power, and flying the aircraft 1 at high speeds and altitudes using high thrusting powers generated by the engines 6. The above described method thus allows reduction of flight time and fuel consumption.

Further, according to the present embodiment, provided is a method including decelerating the aircraft to a predetermined flying speed through stopping the engines from generating the thrust; and then making a landing, thereby allowing the aircraft 1 to be decelerated or descended without causing a stress to the fuselage of the aircraft 1. As the result, fuel consumption can be reduced.

Further, according to the present embodiment, the primary wings 3 are delta wings having sweptback angles, thereby providing large wing areas, thus obtaining a large lifting power F. For this reason, the aircraft 1 can take advantage of this lifting power F to allow itself to be elevated to a high altitude.

Further, according to the present embodiment, there can be obtained a sufficient thrusting power while traveling through the air because of a functionality of the engines 6 being jet engines.

Moreover, in the present embodiment, since the engine 6 is a rocket engine, there can be obtained a sufficient thrusting power for traveling through a high altitude having thin air.

Moreover, the present invention is not limited to the above embodiment s and may include various modifications and changes within the scope of the present invention. For instance, the engines 6 may be attached to the fuselage or the vertical tail.

What is claimed:

1. A method of flying an aircraft having a fuselage, primary wings, and driving units for generating a thrust, said method comprising:
determining a combination of said primary wings and said driving units so that a total wing area of said primary wings is proportionally correlated to an power output of said driving units,
generating a comparatively large lifting power using said primary wings having large wing areas,
elevating said aircraft to a high altitude by said lifting power, and
flying said aircraft at high speeds and altitudes using high thrusting powers generated by said driving units.

2. The method of flying an aircraft according to claim 1, wherein said method further comprises: decelerating said aircraft to a predetermined flying speed through stopping said driving units from generating thrusts; and thereafter making a landing.

3. The method of flying an aircraft according to claim 1, wherein said primary wings are delta wings having sweptback angles.

4. The method of flying an aircraft according to claim 2, wherein said primary wings are delta wings having sweptback angles.

5. The method of flying an aircraft according to claim 1, wherein said driving units are jet engines.

6. The method of flying an aircraft according to claim 2, wherein said driving units are jet engines.

7. The method of flying an aircraft according to claim 3, wherein said driving units are jet engines.

8. The method of flying an aircraft according to claim 4, wherein said driving units are jet engines.

9. The method of flying an aircraft according to claim 1, wherein said driving units are rocket engines.

10. The method of flying an aircraft according to claim 2, wherein said driving units are rocket engines.

11. The method of flying an aircraft according to claim 3, wherein said driving units are rocket engines.

12. The method of flying an aircraft according to claim 4, wherein said driving units are rocket engines.
